(19) United States
(12) Patent Application Publication
(10) Pub. No.: US 2019/0066044 A1
(43) Pub. Date: Feb. 28, 2019

(54) SCHOLAR STARTER SYSTEM

(71) Applicant: ipCapital Group, Inc., Williston, VT (US)

(72) Inventors: John Cronin, Jericho, VT (US); Michael D'Andrea, Burlington, VT (US); William M. Peters, SR., Essex Junction, VT (US); William M. Peters, JR., Essex Junction, VT (US)

(21) Appl. No.: 16/112,618

(22) Filed: Aug. 24, 2018

Related U.S. Application Data
(60) Provisional application No. 62/549,689, filed on Aug. 24, 2017.

(51) Int. Cl. G06Q 10/08; G06Q 30/06; H04W 4/80

(52) U.S. Cl. CPC G06Q 10/0833; H04W 4/80; G06Q 30/0641; G06Q 30/0617

(57) ABSTRACT

This invention relates to a system and method for distributing new products in the selected regions, such as university, college by incentivizing a member, such as students of the university, from the same region. The scholar starter network includes; key student module, new student module, new school module, new company module, ordering application module, tracking module, key student database, school database and product database. The key students are incentivized by the university and/or the product supplier to promote sales of the product on their campus. The university sets the parameters for distribution, including but not limited to, distribution locations, product types, and distribution enticements. Key students utilize a mobile app to view and order available products to at least one of the university approved distribution sites. Products progress through the supply chain is tracked by NFC tags in the product packaging and reported to the key student's mobile app.

### CROSS REFERENCE TO RELATED APPLICATIONS

Not applicable

### FEDERALLY SPONSORED RESEARCH AND DEVELOPMENT

Not applicable

### MICROFICHE

Not applicable

### FIELD OF THE INVENTION

The present invention generally relates to the field of distribution system. The invention, particularly relates to a system and method for distributing new products in the selected regions by incentivizing a member from the same region.

BACKGROUND OF THE INVENTION

Starting to study at university is like starting a new life. When students leave home for university, they embark on a new journey, one that of self-reliance and self-discovery, which largely shapes up their outlook on life in the longer run. Most students are not prepared for the challenges of university and end up being overwhelmed, which results in them taking extra time to adjust to their new life. That is fine, as long as you eventually get comfortable with university life, but a far better course of action would be to prepare yourself, mentally and emotionally, for any problem you may face at college and university level. “Time management” and “Debt” are two major problems faced by the students in the colleges or in universities. Students has very limited time to buy their daily needful products such as food, books, beverages, school supplies and further that too at affordable pricing. Students are forced to juggle full academic schedules with full-time jobs to make ends meet.

Further, supply chain has become an important issue for every organization. Individual businesses and organizations no longer compete as independent and autonomous entities, but are obliged to form supply chains, and networks of multiple businesses and complex inter-relationships, in order to assure their smooth operation and flow of inputs and outputs. Additionally, distribution management is also one of the important parts connected with the supply chain management. Overseeing the movement of goods from supplier or manufacturer to point of sale. Distribution management is an overarching term that refers to numerous activities and processes such as packaging, inventory, warehousing, supply chain and logistics. When new products are being launched by branded companies or by startups companies, they have different issues to overcome relating to advertising, supplying, distributing, and maintaining inventory.

The present invention is a way to provide system for distributing products (food, beverages, school supplies, etc.) on college or university campuses.

A number of different types systems and methods for supply chain and/or distribution management are available in the prior art. Prior art U.S. Pat. No. 9,443,276 to Barry discloses an electronic device enabled with a Near Field Communications (“NFC”) reading capability may perform event-based asset tracking and/or order adherence, and/or rewards management in conjunction with a software service platform. Prior art U.S. Pat. Appl. No. 2002/0073027 to Hui discloses a mobile payment system and method thereof, wherein the customer's payment is verified by sending confirmation back to the customer's device, so as to prevent passing any personal confidential information such as credit card numbers, customer's name and signature to the merchant. Prior art U.S. Pat. No. 6,061,660 to Eggleston discloses systems and methods for conducting enticement programs over computer networks, such as the Internet.

There remains a constant need in smaller a community, such as university or college, to supply and distribute products quickly and at an affordable rate by a novel and improved system.

### SUMMARY OF THE INVENTION

In the view of the foregoing disadvantages inherent in the known types systems and methods for supply chain and/or distribution management now present in the prior art, the present invention provides an improved system for distributing products. As such, the general purpose of the present invention, which will be described subsequently in greater detail, is to provide a new and improved which has all the advantages of the prior art and none of the disadvantages.

The present invention is a system to distribute products to university campuses that utilizes key students at the university as distributers. The key students are incentivized by the university and/or the product supplier to promote sales of the product on their campus. The university sets the parameters for distribution, including but not limited to, distribution locations, product types, and distribution enticements. Key students utilize a mobile app to view and order available products to at least one of the university approved distribution sites. Key students will be shown products related to their ordered products along with enticement structures for sales of each available product. Products progress through the supply chain is tracked by NFC tags in the product packaging and reported to the key student's mobile app. Key student progress towards enticement goals is tracked and redemption options are peddled through the app.

An object of the invention is to provide a system for distributing products within a university by students as distributers, the system comprising: a scholar starter network, wherein the scholar starter network comprises a key student module, a new student module, a new school module, a new company module, ordering application, a tracking module, a key student database, a school database and a product database; at least one brand network, wherein said brand network is configured to provide information related to products and services peddled by brand companies to students through said scholar starter network; at least one start-up network, wherein said start-up network is configured to provide information related to products and services peddled by start-up companies to students through said scholar starter network; at least one school network, wherein said school network has a student database, that stores information related to students, wherein said school network further has an inventory database; a plurality of mobile devices, wherein said mobile devices comprising web-based or mobile-app installed on it; and a plurality of Near Field Communication (NFC) scanners, wherein NFC scanners are configured to scan NFC codes or NFC tags.

It is another object of the present invention to provide a scholar starter network for distributing products within a university by students as distributers, the system comprising: an ordering application module for receiving orders from ordering students and supplying products to said ordering students; a new school module for system administrator to enroll new school into the scholar starter system by evaluating the school location, size, and capabilities of all distribution sites on the campus; a new student module for adding new students to the scholar starter system as a key student by evaluating criteria selection of the new student as defined by the scholar starter system; a key student module for polling the school databases for new data events related to key students; a new company module for system administrator to enroll new company to the scholar starter system; and a tracking module for tracking products using NFC tags or NFC codes among student, university and companies.

It is another object of the present invention to provide a distribution system to coordinate distribution of products within a university, the system comprises a scholar starter network configured to: receive an order placed by an ordering student associated with the university; identify the GPS location of the ordering student; identify one or more key students based on the location of the ordering student and present a list of one or more key students to the ordering student; allow the ordering student to select at least one key student from the one or more key students to fulfil the order; and notify the key student about the order.

It is another object of the present invention to provide a method of coordinating distribution of products within a university, the method comprising: receiving, by a scholar starter network, an order placed by an ordering student associated with the university; identifying, by the scholar starter network, the location of the ordering student; identifying, by the scholar starter network, one or more key students based on the GPS location of the ordering student and present a list of one or more key students to the ordering student; allowing, by the scholar starter network, the ordering student to select at least one key student from the list to fulfil the order; and notifying, by the scholar starter network, the key student about the order.

The system or scholar starter network is a combination of software or hardware and further the method of coordinating distribution of products can also be a combination of software or hardware. The software can be web-based or mobile-app.

The system may also comprises communication network if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art.

The system also comprises internet cloud, which further comprises processing elements and a memory for storing data. The internet cloud may be connected with the mobile devices of the key students and ordering students, school distribute network, brand networks, startup networks, different databases and NFC scanners.

The system also comprises interface(s), which may assist an operator in interacting with the system. The interface(s) of the system may either accept an input from the member of the system or provide an output, or may perform both the actions. The interface(s) may either be a Command Line Interface (CLI), Graphical User Interface (GUI), or a voice interface. Eye tracking, motion/gesture tracking.

The supply, distribution, and inventory of the products in the system can be tracked by different type of sensors/tags attached with the products or in the system, which can be high frequency RFID, Near Field communication (NFC), Infrared (IR), magnetic, electromagnetic and other type of sensors.

The system and method described in the present invention can also be used to distribute products in a university is not limited to students but other members of the university, such as academic staff members, administrative staff members, or any other members of the university. Further, the present system and method can also be implemented to distribute products in a selected region/area/town/city by utilizing members of the respective region/area/town/city as distributors.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 shows schematic view illustrating a scholar system network, one of the embodiments of this invention.

FIG. 2 shows different schematic view illustrating a scholar system network as same as FIG. 1.

FIG. 3 illustrates an example by a flow chart of ordering module.

FIG. 4 illustrates an example by a flow chart of new school module.

FIG. 5 illustrates an example by a flow chart of new student module.

FIG. 6 illustrates an example by a flow chart of key student module.

FIG. 7 illustrates an example by a flow chart of new company module.

FIG. 8 illustrates an example by a flow chart of tracking module.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

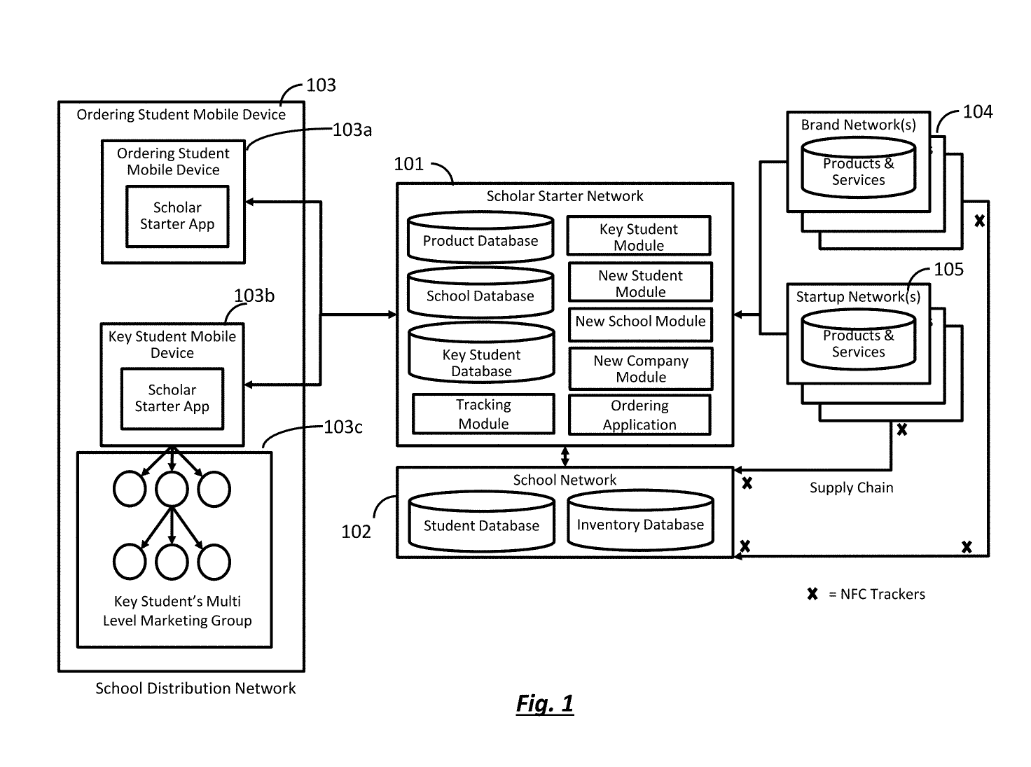

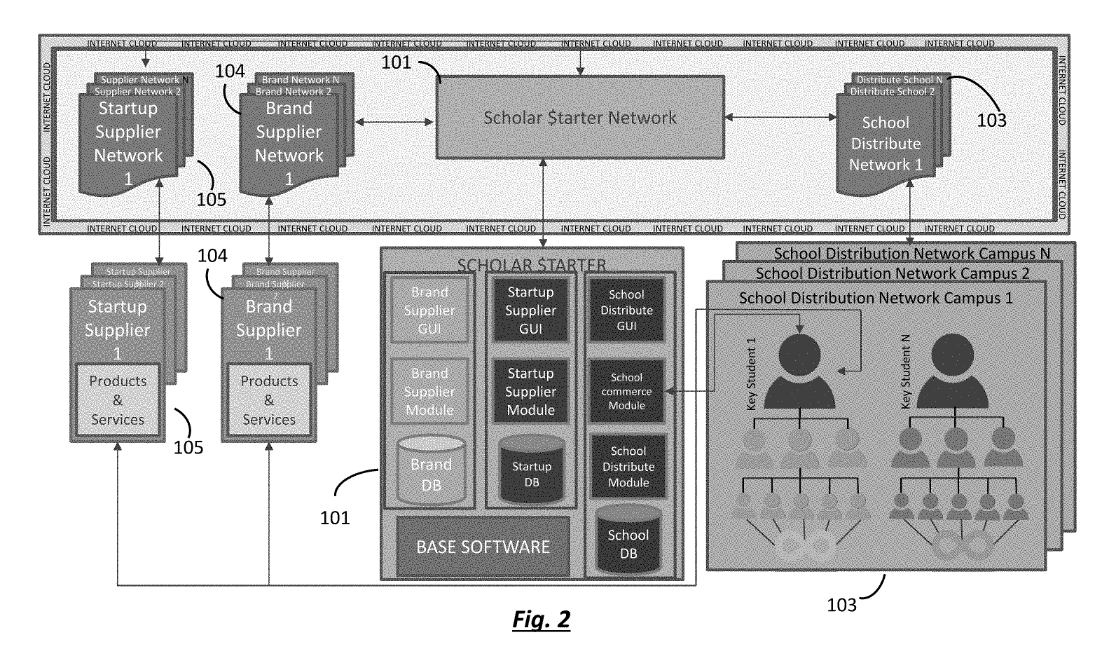

FIGS. 1 and 2 show schematic view illustrating a scholar starter system network, one of the embodiments of this invention. The present invention is a system to distribute new products to university campuses that utilizes key students at the university as distributers. The key students are receiving enticement by the university and/or the product supplier to promote sales of the product on their campus. The system includes; the scholar starter network 101, brand network(s) 104, startup network(s) 105, school network(s) 102, key student mobile device(s) 103b, ordering student mobile device(s) 103a and a plurality of NFC scanners at distribution points at schools and throughout the supply chain.

The brand network(s) 104 have a database with available products and services that company is offering through scholar starter. The startup network(s) 105 have a database with available products and services that company is offering through scholar starter. The key student and ordering student mobile devices 103a and 103b have the scholar starter app on them and an NFC reader. The school network 102 has a student database that stores information related to students including GPA, programs enrolled in, disciplinary record, etc. The school network 102 also has an inventory database which contains all the available inventory of products at their distribution location(s). The inventory database is where data events from NFC scans along the supply chain are stored.

The scholar starter network 101 includes; key student module, new student module, new school module, new company module, ordering application, tracking module, key student database, school database and product database. The product database contains all products peddled by all brands and startups at all schools participating in scholar starter, along with the enticements provided by the brand or startup associated with those products. The school database contains the location of distribution centers and products peddled at each school participating in scholar starter. The key student database contains the information for each subscribed key student, including the school they are working at and the eligibility criteria their school has defined for them to maintain key student status.

The ordering application that is accessed via key students and ordering students through their mobile devices 103a and 103b. The module itself is located on the scholar starter network. The process begins when an ordering student logs into the scholar starter app. The system then identifies the GPS location of the ordering student's mobile device, and identifies the school at which the ordering student is located. All available products are retrieved from the inventory database of the school at which the ordering student is located. The product options are then displayed on the ordering student's mobile device 103a. The product selection(s) are received and the key students at the school are identified from the key student database 103b.

The available key student(s) (in this example available key student is defined as one who is currently logged into the scholar starter app) are displayed for the ordering student to select which key student they wish to have fulfill their order. In alternate embodiments if the ordering student is a part of a key student's multi-level marketing (MLM) group, that student is automatically selected if they are logged into the scholar starter app. In alternate embodiments the available key students could be sorted by distance from the available product distribution site and/or the ordering student's location. In this embodiment the user can either send their request to a specific key student, or send it to all available key students. The request is in the form of a message on the key student's mobile device that includes the quantity and type of product(s) ordered, their distribution locations and the location of the ordering student's mobile device. If the ordering student elects to send the request to all available students, the first student to claim the order gets to fulfill it and a message is sent to all key students who received the initial order message that states “order claimed”.

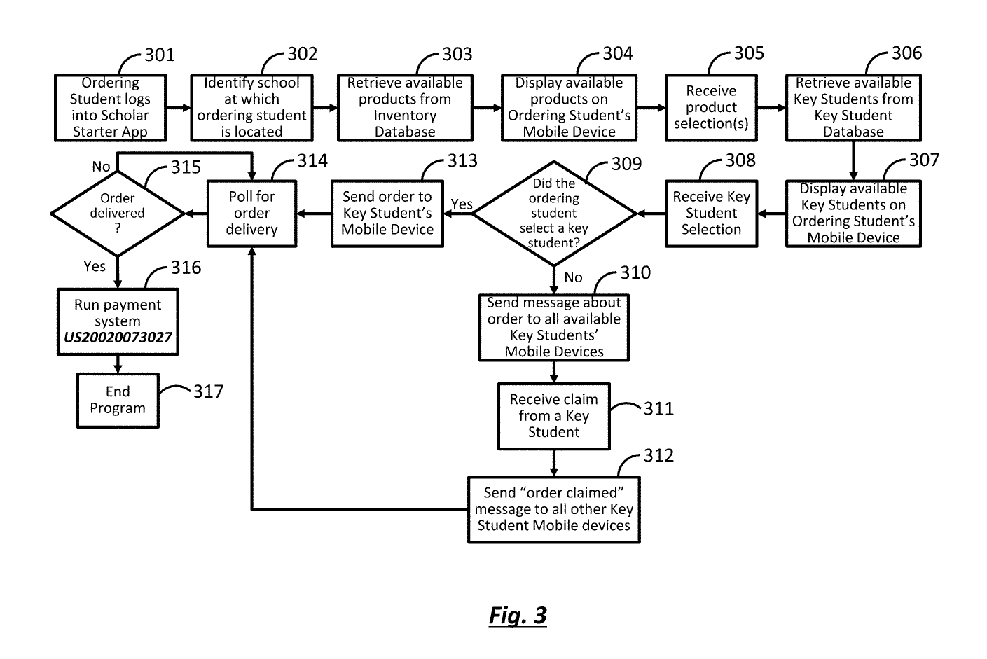

FIG. 3 illustrates an example by a flow chart of ordering module. This figure depicts the ordering application that is accessed via key students and ordering students through their mobile devices. The module itself is located on the scholar starter network. As shown in block 301, the process begins when an ordering student logs into the scholar starter app. The system then identifies the GPS location of the ordering student's mobile device, and identifies the school at which the ordering student is located Block 302. In the next Block 303, all available products are retrieved from the inventory database of the school at which the ordering student is located. The product options are then displayed on the ordering student's mobile device Block 304. In the Block 305, the product selection(s) are received. In next block 306, all available key students are retrieved from the key student database of the school at which the ordering student is located. The key student(s) options are then displayed on the ordering student's mobile device Block 307. The key student selection is received from the ordering student mobile device Block 308. In Block 309, the ordering student has choice to select key student or not. If the ordering student has selected the key student then process flows thru Block 313 route, otherwise the process flows thru block 310 route. If, the ordering student has selected the key student then the order is send to the key student/key student's mobile device Block 313.

If ordering student has not selected then the system sends out the message about the order to all available key students in the respective area/school Block 310. The system receives a claim message from the key student who has accepted the order Block 311. Then the system sends out “order claimed” message to all key students in the respective area/school Block 312.

In the next block 314, poll for order delivery starts. The system tracks the order, whether the order is delivered or not? Block 315. Once the order reach to the ordering student then the payment system processes the payment Block 316. Once the order delivered to the ordering student after payment the process completes Block 317.

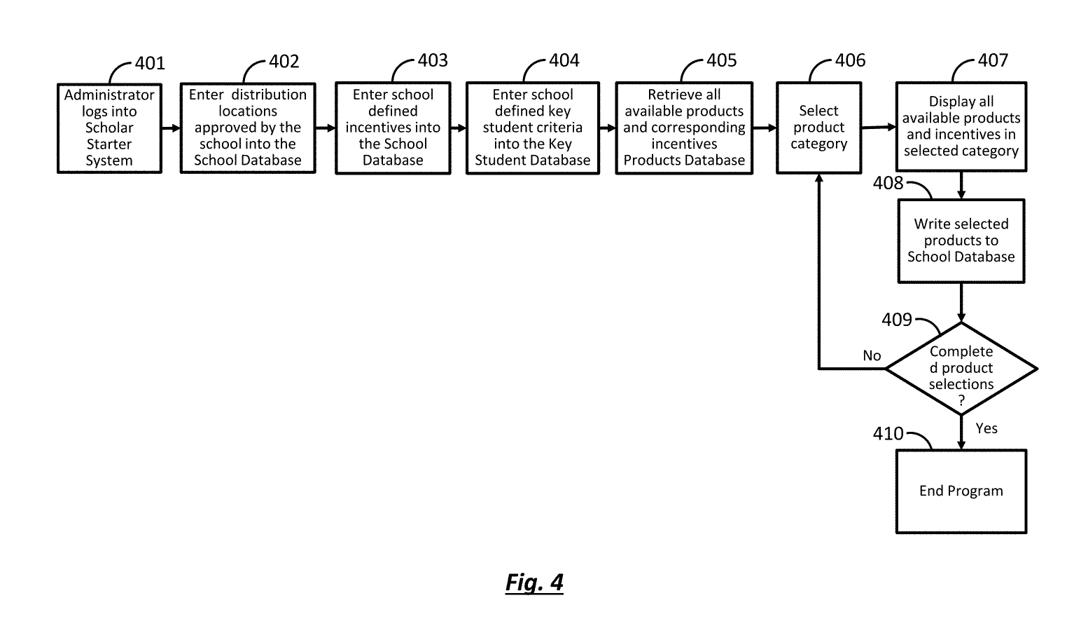

FIG. 4 illustrates an example by a flow chart of new school module. The system described here is the new school module located on the scholar starter network. The process initiates once the system administrator logs into the system Block 401. This system is run by an administrator with scholar starter who collects the necessary data from school(s) that wishes to have the scholar starter system on their campus. The administrator will identify the size, location and capabilities (such as freezing and refrigeration) of all distribution sites on the campus. As shown in the next Block 402, the administrator also collects enticements the school wishes to offer, such as course credit, work study, etc., and that data goes into the school database along with the distribution locations Block 403. The administrator then enters the schools criteria for a key student into the key student database Block 404. Key student criteria could include things such as, minimum GPA, participation is a specific program or major (such as MBA or marketing students), behavior standards, etc. The administrator retrieves the list of all available products and enticements for the school Block 406. In the next blocks 406 and 407 all available products, and the corresponding enticements peddled by the supplying brand or startup, are displayed for the administrator to present to the school. Then the administrator writes all selected products to school databse Block 408. The school selects each of the products they wish to have stocked and peddled on their campus Block 409. The system will prevent competing products from being peddled by, for example, offering the products by category first. For example, the school may wish to have coffee peddled through the scholar starter system. Once they select coffee, and select from available coffee brands, those not selected will not be available for future selection. Unless the original product is removed from the list/system. After the school completes the selection of the products the process completes Block 410.

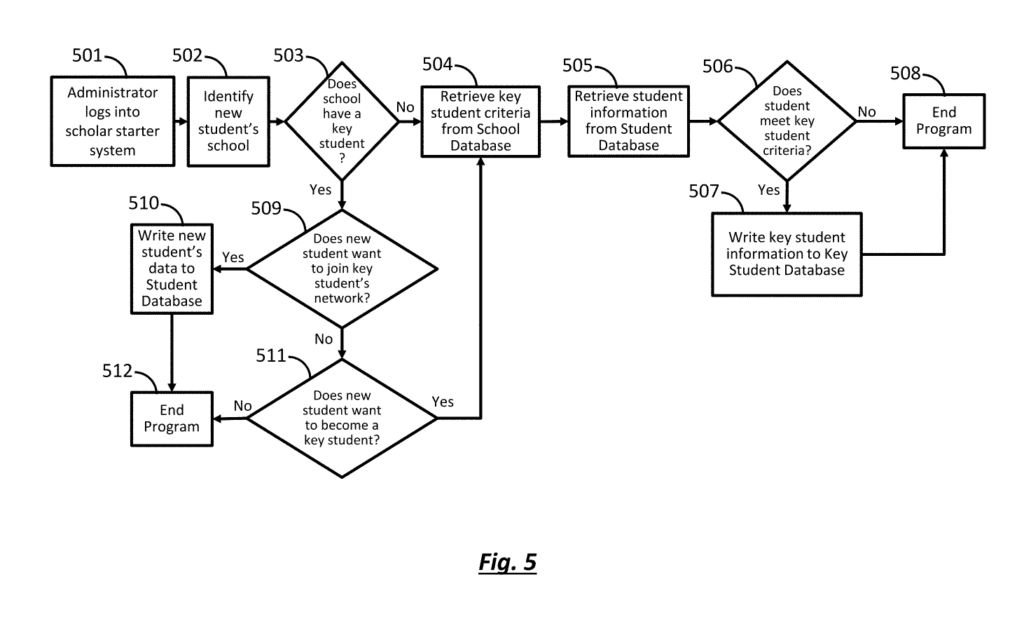

FIG. 5 illustrates an example by a flow chart of new student module. The system described here is the new student module for adding students to the scholar starter system. This system is triggered when a new student contacts scholar starter to become a key student and an administrator logs into the scholar starter system Block 501. In the next Block 502, the new student's school is identified based upon either their answer to a question or by the GPS location of their mobile device. Does the school for which the student wishes to become a key student already have a key student? Block 509. If yes, then the process flows thru the Block 509 route. Does new student (who is already a Key student earlier) want to join Key student's network? (Block 509). If “Yes”, then the system writes new student's data to the student database Block 510. In case, the new student is not a Key student, does new student wishes to become a key student (Block 511) and process flows thru the Block 504 route. If, the new student is not interested to become a key student then the new student module “End the process” Block 512.

In case if school do not have any key student enroll in the system then the process flows thru the Block 504. The criteria established by the school for a key student is retrieved from the key student database Block 504. The student contacting scholar starter then has their student information retrieved from the student database at the school in question Block 505. If the inquiring student meets the school's criteria for becoming a key student, the inquiring student is labeled a key student and has their information, including information about their mobile device for tracking and contact purposes, is then written to the key student database Block 507. If the school in question has a key student, the inquiring student can either become a member of an existing key student's MLM or go through the steps already listed to become a key student.

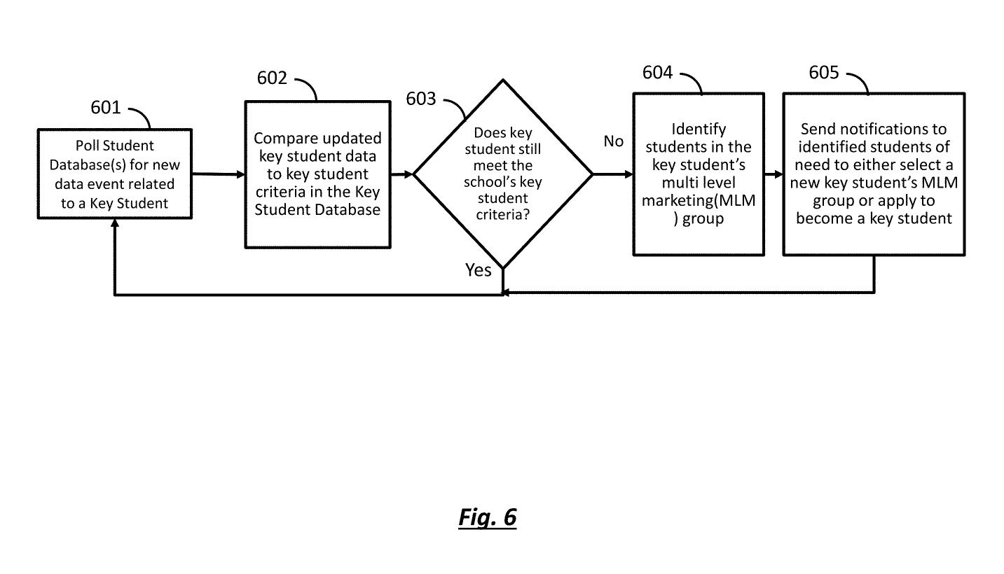

FIG. 6 illustrates an example by a flow chart of key student module. The system described here is the key student module. This system is constantly polling the school databases for new data events related to key students Block 601. When a new data event is detected the updated student information is compared to the key student criteria established by the school in the key student database Block 602. In next Block 603, the system checks whether the key student meets the criteria to be a key student or not. If the student still meets the criteria to be a key student the system goes back to polling for new data events. If the updated student information no longer meets the criteria to be a key student, the students in the key student's multi-level marketing group are identified Block 604. Those students identified are sent a message through the scholar starter app that allows them to either apply to be a key student themselves, or join the MLM of another key student at the school Block 605. In alternate embodiments, one of the now ineligible key student's MLM group is automatically assigned as the key student of the MLM group.

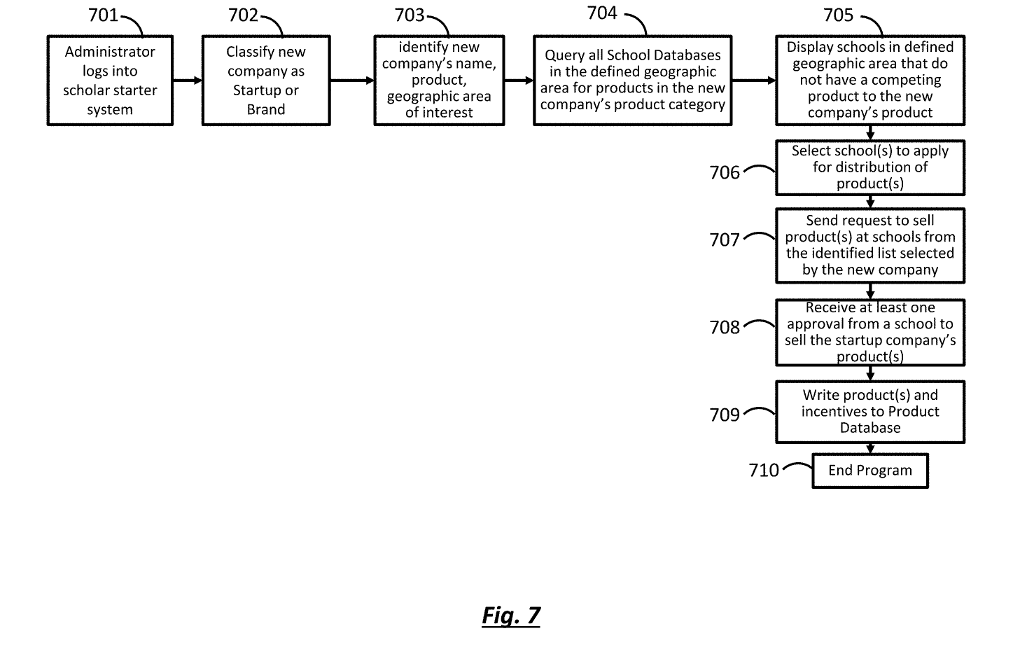

FIG. 7 illustrates an example by a flow chart of new company module. The system described here is the new company module. The system begins when an administrator logs into the scholar starter system when they have been contacted by a company that wants to offer their products or services through the scholar starter system Block 701. In the next block 702, the company is first classified as a startup or a brand. This can be based on a number of different factors, including annual sales/revenue, name recognition, etc. This could also be done regionally. For example, some stores are regional and would be considered brands if they were to apply to sell at a school in their region. Those same companies could be classified as startups in regions in which they do not have a presence. The new company's name, product(s) and geographic area of interest are entered into the system by the administrator Block 703. The school databases for schools in the defined geographic area are then queried for products in the applying company's product category, such as coffee, cookies, razors, etc. Block 704. In the next blocks 705 and 706, the schools in the defined geographic area that do not have a competing product are displayed for the administrator to present to the applying company to select from. The system sends requests to distribute the applying company's identified product(s) to each school the applying company selects Block 707. Once at least one school approves the distribution request, the product(s) and their enticements are written to the product database Blocks 708 and 709.

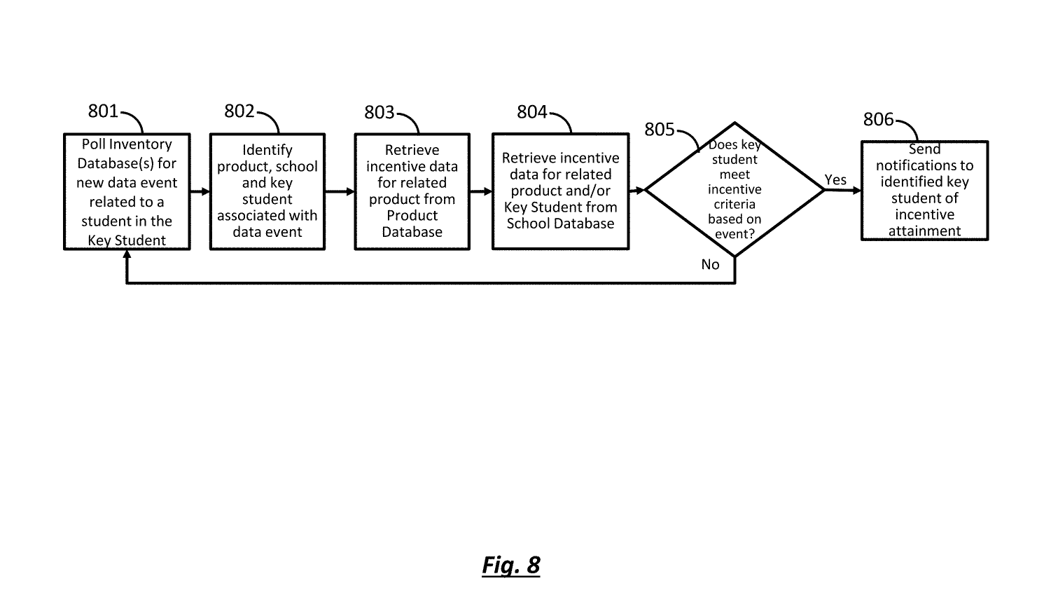

FIG. 8 illustrates an example by a flow chart of tracking module. The system described here is the tracking module. The system is always polling the inventory database(s) of participating schools for new data events Block 801. Data events come from the NFC tracking system used to track product location, such as the one described in U.S. Pat. No. 9,443,276. This system has NFC trackers at the point of supply from the brand or startup, at various points along the supply chain and at the distribution locations. When a new data event is detected the product, school and key student associated with the data event are identified Block 802. Some data events, such as those in the supply chain, will not have a key student associated with them and the system will take no action. This data can be delivered to school, brand, startup or scholar starter for tracking and fulfillment purposes. In the next Block 803, the enticement data related to the product associated with the data event is retrieved from the product database. Enticement data for the related product and/or key student is then retrieved from the school database Block 804. The school database can have enticements related to specific products and also for the student that are not product specific. For example, the student may receive work-study credit only when they deliver 100 items. That enticement would be product independent, whereas an enticement in which the student gets cafeteria credit when they sell 25 cookies is product dependent. In the next Block 805, does the new data event allow a key student to meet an enticement criteria? If yes, the student is sent a notification Block 806. If no, the system returns to polling for new data events and the process flows back to Block 801.

The available key student(s) (in this example an available key student is defined as one who is currently logged into the scholar starter app) are displayed for the ordering student to select which key student they wish to have fulfill their order. In alternate embodiments if the ordering student is a part of a key student's multi-level marketing (MLM) group, that student is automatically selected if they are logged into the scholar starter app. In alternate embodiments the available key students could be sorted by distance from the available product distribution site and/or the ordering student's location. In this embodiment the user can either send their request to a specific key student, or send it to all available key students. The request is in the form of a message on the key student's mobile device that includes the quantity and type of product(s) ordered, their distribution locations and the location of the ordering student's mobile device. If the ordering student elects to send the request to all available students, the first student to claim the order gets to fulfill it and a message is sent to all key students who received the initial order message that states “order claimed”.

The system then polls for order delivery. An order is considered delivered when the product NFC tag is scanned by the ordering student's mobile device, or when the payment is processed. In alternate embodiments, the ordering student will get updates on the position of the key student' mobile device during the delivery process, and/or the timing and location of NFC scans of the product (such as a scan when it leaves the distribution facility). When the order is delivered a mobile payment is taken, in a manner such as that described in US20020073027. Once payment has been received the program ends.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e. g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e.g., a modem or network connection).

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1: A system for distributing products within a university by students as distributers, the system comprising:
A scholar starter network,
At least one brand network, wherein said brand network is configured to provide information related to products and services peddled by brand companies to students through said scholar starter network;
At least one start-up network, wherein said start-up network is configured to provide information related to products and services peddled by start-up companies to students through said scholar starter network;
At least one school network, wherein said school network has a student database, that stores information related to students, wherein said school network further has an inventory database;
A plurality of mobile devices, wherein said mobile devices comprising web-based or mobile-app installed on it; and
A plurality of scanners.

2: The system for distributing products within a university by students as distributers according to claim 1, wherein the scholar starter network comprises a key student module, a new student module, a new school module, a new company module, ordering application, a tracking module, a key student database, a school database and a product database;

3: The system for distributing products within a university by students as distributers according to claims 1 and 2, wherein the scholar starter network comprising:
An ordering application module for receiving orders from ordering students and supplying products to said ordering students;
A new school module for administrator to enroll new school into the scholar starter system by evaluating the school location, size, and capabilities of all distribution sites on the campus;
A new student module for adding new students to the scholar starter system as a key student by evaluating criteria selection of the new student as defined by the scholar starter system;
A key student module for polling the school databases for new data events related to key students;
A new company module for system administrator to enroll new company to the scholar starter system; and
A tracking module.

4: The system for distributing products within a university by students as distributers according to claim 1, wherein the scanners comprise Near Field Communication (NFC) scanners, IR scanners, RFID scanners, magnetic scanners, and any similar kind of scanners.

5. The system for distributing products within a university by students as distributers according to claim 4, wherein NFC scanners are configured to scan NFC codes or NFC tags.

6: The system for distributing products within a university by students as distributers according to claim 3, wherein the tracking module is for tracking products using NFC tags or NFC codes, retrieving enticement data from the product database, identifying key student for that particular order, checking eligibility of the key students of enticements, and sending notifications to the key students of enticement attainment.

7: A distribution system to coordinate distribution of products within a university, the system comprises a scholar starter network configured to:
receive an order placed by an ordering student associated with the university;
identify the GPS location of the ordering student;
identify one or more key students based on the location of the ordering student and present a list of one or more key students to the ordering student;
allow the ordering student to select at least one key student from the one or more key students to fulfil the order;
notify the key student about the order; and
allocate enticements to the key student on the system.

8: A method of coordinating distribution of products within a university, the method comprising:
receiving, by a scholar starter network, an order placed by an ordering student associated with the university;
identifying, by the scholar starter network, the location of the ordering student;
identifying, by the scholar starter network, one or more key students based on the GPS location of the ordering student and present a list of one or more key students to the ordering student;
allowing, by the scholar starter network, the ordering student to select at least one key student from the list to fulfil the order;
notifying, by the scholar starter network, the key student about the order;
delivering, by the scholar starter network, the order to the ordering student;
receiving payment from the ordering students; and
allocating enticements to the key student on the system.

9: The method of coordinating distribution of products within a university, wherein the method is for identifying and sorting one or more key students, after receiving the order, based on availability of the key student and distance from at least one of an available product distribution site and the user.

10: The method of coordinating distribution of products within a university, wherein the method is for creating a multi-level marketing (MLM) group for each university within which multiple levels of inter-relationship between a key student and the users are created, and wherein automatically selecting a specific key student, if the user is a part of a MLM group of the specific key student if is the specific key student is logged into the scholar starter application.
